(19) United States
(12) Patent Application Publication
(10) Pub. No.: US 2002/0001183 A1
(43) Pub. Date: Jan. 3, 2002

(54) SURFACE EMISSION LIGHT SOURCE DEVICE AND METHOD OF MANUFACTURING LIGHT GUIDE PLATE WITH REFLECTING PLATE THEREFOR

(76) Inventor: ARIYAMA SHIGEHIRO, GYODA-SHI (JP)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/322,258

(22) Filed: May 28, 1999

(30) Foreign Application Priority Data
Jun. 1, 1998 (JP) 151244/1998

(51) Int. Cl. G01D 11/28

(52) U.S. Cl. 362/23

(57) ABSTRACT

A surface emission light source device includes a light source, a light guide plate, and a reflecting plate. The light guide guides light from the light source and causes the light to emerge from its front surface. The reflecting plate has an irregular-reflection surface formed of irregular corrugations, and is disposed on a lower surface of the light guide plate. The reflecting plate diffuses and reflects the light guided through the light guide plate with the irregular-reflection surface, and causes the diffused/reflected light to emerge from the front surface of the light guide plate. The light guide plate and the reflecting plate are integrally formed by molding, to bond the irregular-reflection surface to the lower surface of the light guide.

### BACKGROUND OF THE INVENTION

The present invention relates to a surface emission light source device used as, e.g., a light source for the transmission illumination dial of an analog display indicator or a backlight source for the LCD panel of a digital display indicator, and a method of manufacturing a light guide plate with a reflecting plate for this device.

In an analog or digital display indicator, to uniform the illumination balance is significant particularly in so-called entire-surface illumination in which, even in illumination of a dial or entire LCD display panel, display portions (characters, numerals, figures, signs, and the like) do not transmit light but the remaining portion does. For this reason, in this indicator, a surface emission light source device for uniformly illuminating a large area is used as a light source. As this surface emission light source device, although a panel light source such as an EL device may be possible, it is expensive. Therefore, a surface emission light source device constituted by a point or line source, e.g., a light bulb or cold-cathode tube, a light guide plate, and a reflecting plate is most popular.

FIGS. 20 to 24 show a conventional automobile analog display indicator using a surface emission light source device. In FIGS. 20 to 24, reference numeral 1 denotes an analog display indicator; 2, a case; 3, a dial; and 4, a light-diffusing plate. Reference numerals 5 denote light sources; 6, a light guide plate; and 7, a reflecting plate. The light sources 5, light guide plate 6, and reflecting plate 7 form the surface emission light source device for illuminating the dial 3.

In the dial 3, the entire front surface of a crystal-clear transparent material such as a polycarbonate resin is printed in white, and black printed portions (blanks of display portions) 10 are formed on portions other than display portions 9, e.g., numerals, characters, signs, and figures. The light sources 5 are arranged behind the dial 3. Light from the light sources 5 is guided to the front surface of the light guide plate 6 and diffused by the light-diffusing plate 4, thereby illuminating (by transmission) the display portions 9. As the light sources 5, light bulbs as point sources are usually used. Alternatively, cold-cathode tubes as line sources are sometimes used. The light guide plate 6 is made of an acrylic resin or the like, and is formed with light source holes 11 into which the light sources 5 are to be inserted, and holes 14 through which shafts 13 of pointers 12 extend. Light emitted by the light sources 5 to come incident on the light guide plate 6 is multiple-reflected by the upper and lower surfaces of -the light guide plate 6 and emerges to the front surface. The reflecting plate 7 has a diffusing/reflecting surface 15 made of fine corrugations. The reflecting plate 7 diffuses and reflects light leaking to the lower surface of the light guide plate 6 with its corrugations and causes it to come incident on the light guide plate 6 again, so that light is utilized effectively. Cylindrical portions 21a of indicator caps 21 are connected to the shafts 13 of cross coils (not shown) for driving an analog display indicator.

FIG. 25 show a light guide plate of another conventional automobile analog display indicator, and FIG. 26 shows this indicator in section along the line C-C in FIG. 25. As the light source, this automobile analog display indicator 16 uses a cold-cathode tube 17 serving as a line source. The amount of light guided to the front surface of a dial 3 increases nearer the cold-cathode tube 17 (the same applies to a point source 5) and decreases farther from the cold-cathode tube 17. As a result, of the display portions, those near the cold-cathode tube 17 are bright while those far from the cold-cathode tube 17 are dark. Fine dots 18 are printed on the lower surface of a light guide plate 6 with a white translucent ink or the like, to be coarse (or to have small diameters) at the bright portions and dense (or to have large diameters) at the dark portions, thereby adjusting the amount of light to be guided to the front surface of the dial 3. Also, fine dots (not shown) are printed on the lower surface of the dial 3 with a black ink or the like, to be dense (or to have large diameters) at the bright portions and coarse (or to have small diameters) at the dark portions. The amount of light at the bright portions is suppressed in this manner by dot printing, so that the amounts of light transmitted through display portions 9 of the dial 3 become substantially uniform (example: Japanese Patent Publication No. 53-2065).

FIG. 27 shows the main part of a light guide plate as still another conventional example. A white translucent printed layer 19 is formed on the lower surface of a light guide plate 6. The printed layer 19 and a reflecting plate 7 reflect light leaking to the lower surface side of the light guide plate 6.

As still other conventional examples, a display device, a display plate, a light guide plate, and the like disclosed in Japanese Utility Model Laid-Open No. 51-11356, Japanese Utility Model Registration No. 2532748, Japanese Patent Laid-Open No. 09-159493, Japanese Utility Model Laid-Open No. 05-50403, Japanese Patent Laid-Open Nos. 08-279307 and 08-227273, and the like are known.

In the display plate disclosed in Japanese Utility Model Laid-Open No. 51-11356 (to be referred to as prior art 1 hereinafter), reflecting plates for totally reflecting light beams are adhered to the two surfaces of a transparent plate. Blank characters are formed on at least one reflecting surface. Light emitted by a light source, passing through the plate, and reflected by the reflecting plates emerges outside through the blank holes.

In the light guide plate device disclosed in Japanese Utility Model Registration No. 2532748 (to be referred to as prior art 2 hereinafter), a light-diffusing layer serving as a light emission surface is formed on one surface of a transparent resin plate. A reflecting layer serving as a light-shielding surface is integrally brought into tight contact with the other surface of the transparent resin plate and is bonded to it through an irregular reflection layer made of a resin having a refractive index different from that of the transparent resin plate. Light emitted by a light source and coming incident on the light guide plate is efficiently irregularly reflected by the irregular reflection layer.

In the pointer type indicator device disclosed in Japanese Patent Laid-Open No. 09-159493 (to be referred to as prior art 3 hereinafter), a light guide plate is formed on a wiring board through a light-reflecting member constituted by a high-reflection printed layer, a sheet member, a white reflecting surface, and the like. An embossed region is formed on the lower surface of the light guide plate to correspond to index portions. The embossed region diffuses light forward.

In the light guide disclosed in Japanese Utility Model Laid-Open No. 05-50403 (to be referred to as prior art 4 hereinafter), countless corrugations for irregularly reflecting light are formed on its one surface, and reflecting portions having a higher reflectance than that of the corrugations are formed at predetermined portions on the surfaces of the corrugations.

In the surface emission device disclosed in Japanese Patent Laid-Open No. 08-279307 (to be referred to as prior art 5 hereinafter), a surface emission light source device transfer material is placed in a mold. The surface emission light source device transfer material is obtained by forming a light-diffusing/transmitting layer and a side-surface reflecting layer on a base sheet by printing. A molten resin is filled in the mold to form a light guide plate integrally with the surface emission light source device transfer material. After that, the base sheet is separated, thereby transferring the light-diffusing/transmitting layer and the side-surface reflecting layer to the light guide plate.

A light guide for a panel light source device disclosed in Japanese Patent Laid-Open No. 08-227273 (to be referred to as prior art 6 hereinafter) is formed by placing a light-diffusing film in an injection molding mold and injecting a light guide resin into a cavity.

As described above, in the conventional surface emission light source devices described above, light emitted by the light source is guided to the light guide plate, and the dial is illuminated with light emerging from the light guide plate. However, it is difficult for any one of the conventional devices to brightly and uniformly illuminate the entire dial. More specifically, in the analog display indicator shown in FIGS. 20 to 24, an air layer 21 exists between the light guide plate 6 and reflecting plate 7, as shown in FIG. 24. Light coming incident on the light guide plate 6 from the light source 5 is guided far while being multiple-reflected in the light guide plate 6. If the angle of incidence is equal to a critical angle or more, the light repeats total reflection at the boundary surface between the light guide plate 6 and air layer 21. The amount of light leaking to the lower surface of the light guide plate 6 is accordingly small and most light emerges outside through the end face of the light guide plate 6. Even if the reflecting plate 7 is arranged behind the light guide plate 6, the amount of light diffused and reflected by the reflecting plate 7 and guided to the front surface of the dial 3 is small. As a result, when the dial 3 is illuminated, it cannot be entirely illuminated with uniform brightness, and shadows 22 of the holes 14 through which the shafts 13 extends and of the cylindrical portions 21a of the indicator caps 21 (FIG. 23) are formed on the opposite side to the light source 5, as indicated by hatched portions in FIG. 21.

In the conventional analog display indicator shown in FIGS. 25 and 26, the amount of light guided to the front surface of the dial 3 is slightly increased by the white translucent printed dots on the lower surface of the light guide plate 6, and the dark portions become bright. However, uniform illumination cannot often be obtained with the white translucent printed dots alone. In this case, if black dots are printed on the lower surface of the light guide plate corresponding to the display portions 9 on the front surface of the dial 3, substantially uniform illumination can be obtained, but it is difficult to determine the specifications of dot printing aiming at obtaining uniform illumination. The black dots printed on the lower surface of the dial decreases the amount of light transmitted through the bright portions in accordance with the dark portions, so that the entire brightness is adjusted. This makes the entire dial dark. In order to avoid this, measures must be taken such as increasing the rated power of the light source (power consumption), providing a plurality of light sources, and the like.

In the analog display indicator shown in FIG. 27 in which the white translucent printed layer 19 is formed on the lower surface of the light guide plate 6, no layer is present between the light guide plate 6 and white translucent printed layer 19 to diffuse and reflect light. Although light is partly guided to the front surface of a dial 3, most light repeats total reflection at the boundary surface between the light guide plate 6 and white translucent printed layer 19. Therefore, the amount of light guided to the front surface of the dial 3 is small and most light emerges outside through the end face of the light guide plate 6. Light from the light source cannot be utilized effectively, and shadows 22 (FIG. 21) similar to those in the conventional indicator shown in FIGS. 20 to 24 are formed on the opposite side to the light sources 5.

In the display plate disclosed in prior art 1, light coming incident on the light guide plate (plate member) from the light sources is guided far by merely totally reflecting it by the boundary surface between the light guide plate and reflecting plate. All the characters cannot be illuminated with uniform brightness.

The light guide plate device disclosed in prior art 2 has the light-diffusing layer and the irregular reflection layer, and is thus superior to the display plate of prior art 1 described above in terms of effectively utilizing light. However, the thickness of the irregular reflection layer is changed to gradually become close to that of the light-diffusing layer from the light incident surface of the light guide plate toward a surface of the light guide plate opposite to the light incident surface. This increases the manufacturing cost. Light propagating through the light guide partly comes incident on the irregular reflection layer and is absorbed. Thus, light cannot be entirely utilized effectively.

In the indicator display device disclosed in prior art 3, light is merely reflected by the light-reflecting member, in the same manner as in prior art 1 described above, and accordingly cannot illuminate the index portions with uniform brightness. When an embossed region is formed on the lower surface of the light guide plate to correspond to the index portions and light is diffused forward by the embossed region, some index portion is illuminated by the diffused light and the reflected light totally reflected by the light-reflecting member, while some index portion is illuminated mainly with the diffused light. Therefore, all the index portions cannot be illuminated with substantially uniform brightness.

In the light guide disclosed in prior art 4, since a reflecting plate is not formed on the lower surface of the light guide plate, transmitted light emerging outside from the lower surface is lost. This light guide is thus inferior in terms of effectively utilizing light.

Since the surface emission device disclosed in prior art 5 has the side-surface reflecting layer, light is not lost as it is not transmitted through the side surface. This device is thus superior in terms of effectively utilizing light. However, this device requires the step of separating the base sheet to increase the number of manufacturing steps. Also, since light transmitted to the lower surface of the light guide plate is lost, this device is inferior in terms of effectively utilizing light.

In the panel light source device light guide disclosed in prior art 6, the light-diffusing film is integrally formed on the upper surface of a light guide plate. A large number of fine dots are printed on the lower surface of the light guide plate with a white ink or the like to form a light-diffusing/transmitting portion. The light guide also has a light-reflecting film. Therefore, the amount of light emerging to the front surface is small, and bright illumination cannot be obtained.

### SUMMARY OF THE INVENTION

It is an object of the present invention to provide a surface emission light source device having a comparatively simple structure and capable of efficiently utilizing light from a light source, thus increasing an amount of light and enabling uniform illumination entirely, and a method of manufacturing a light guide plate with a reflecting plate for this device.

In order to achieve the above object, according to the present invention, there is provided a surface emission light source device comprising a light source, a light guide plate for guiding light from the light source and causing the light to emerge from a front surface thereof, and a reflecting plate, having an irregular-reflection surface formed of irregular corrugations and disposed on a lower surface of the light guide plate, to diffuse and reflect the light guided through the light guide plate with the irregular-reflection surface and to cause the diffused/reflected light to emerge from the front surface of the light guide plate, wherein the light guide plate and the reflecting plate are integrally formed by molding, to bond the irregular-reflection surface to the lower surface of the light guide.

### BRIEF DESCRIPTION OF THE DRAWINGS

FIG. 1 is a front view showing the main part of an automobile analog display indicator according to an embodiment of the present invention;

FIG. 2 is a front view of a light guide plate;

FIG. 3 is a sectional view of the indicator taken along the line III-III of FIG. 2;

FIG. 4 is a sectional view of the indicator taken along the line IV-IV of FIG. 2;

FIG. 5A is an enlarged sectional view of the main part of the indicator, and

FIG. 5B is an enlarged sectional view of the main part of the light guide plate;

FIG. 6 is a microscopic photograph of the surface of Super Reflector No. 4596 available from Sumitomo 3M K.K.;

FIG. 7 is a graph obtained by measuring the X-direction surface roughness of this reflector;

FIG. 8 is a graph obtained by measuring the Y-direction surface roughness of this reflector;

FIG. 9 is a view showing the sectional image of this reflector;

FIG. 10A is a microscopic photograph of the surface of reflection film Ref-White RW188 available from K.K. Kimoto, and

FIG. 10B is a sectional photograph showing the foamed state of this film;

FIG. 11 is a graph obtained by measuring the X-direction surface roughness of this film;

FIG. 12 is a graph obtained by measuring the Y-direction (a direction perpendicular to the X direction) surface roughness of this film;

FIG. 13 is a view showing the sectional image of this film after molding a light guide plate;

FIG. 14 is a microscopic photograph of the surface of MCPET available from Furukawa Electric Co., Ltd.;

FIG. 15 is a graph obtained by measuring the X-direction surface roughness of the MCPET;

FIG. 16 is a graph obtained by measuring the Y-direction (a direction perpendicular to the X direction) surface roughness of the MCPET;

FIG. 17 is a sectional view of the main part of another embodiment of the present invention;

FIG. 18 is a sectional view of a mold used when manufacturing a light guide plate by outsert molding;

FIG. 19 is a sectional view of a surface emission light source device having a light guide plate formed by outsert molding;

FIG. 20 is a front view showing a conventional automobile analog display indicator;

FIG. 21 is a front view of a light guide plate;

FIG. 22 is a sectional view of this indicator taken along the line A-A of FIG. 18;

FIG. 23 is a sectional view of this indicator taken along the line B-B of FIG. 18;

FIG. 24 is a sectional view showing the main part of a conventional light guide plate;

FIG. 25 is a plan view of a light guide plate of another conventional analog display indicator;

FIG. 26 is a sectional view of this indicator taken along the line C-C of FIG. 22; and

FIG. 27 is a sectional view of the main part of a light guide plate of still another conventional example.

### DESCRIPTION OF THE PREFERRED EMBODIMENTS

The present invention will be described in detail by way of preferred embodiments shown in the accompanying drawings.

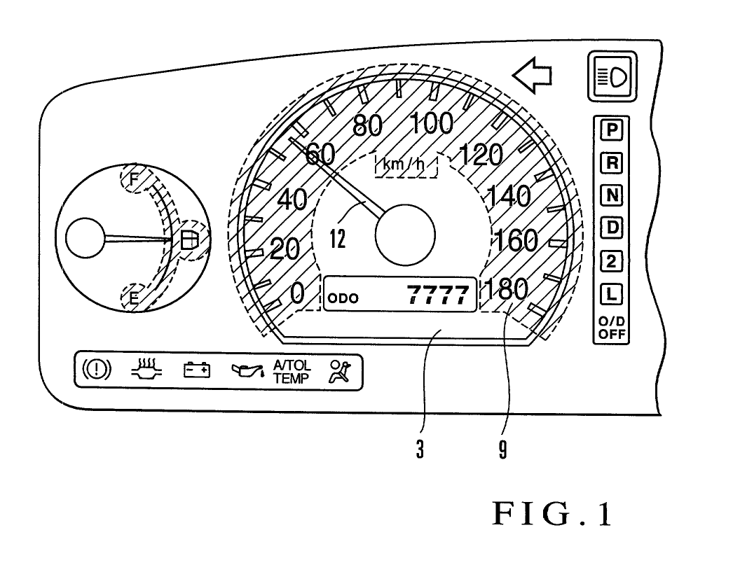

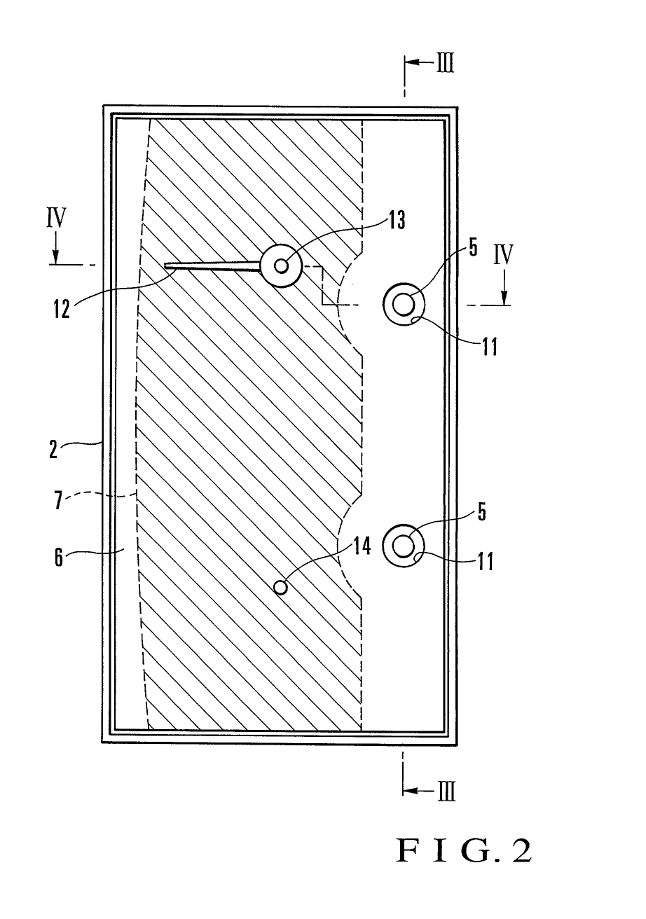

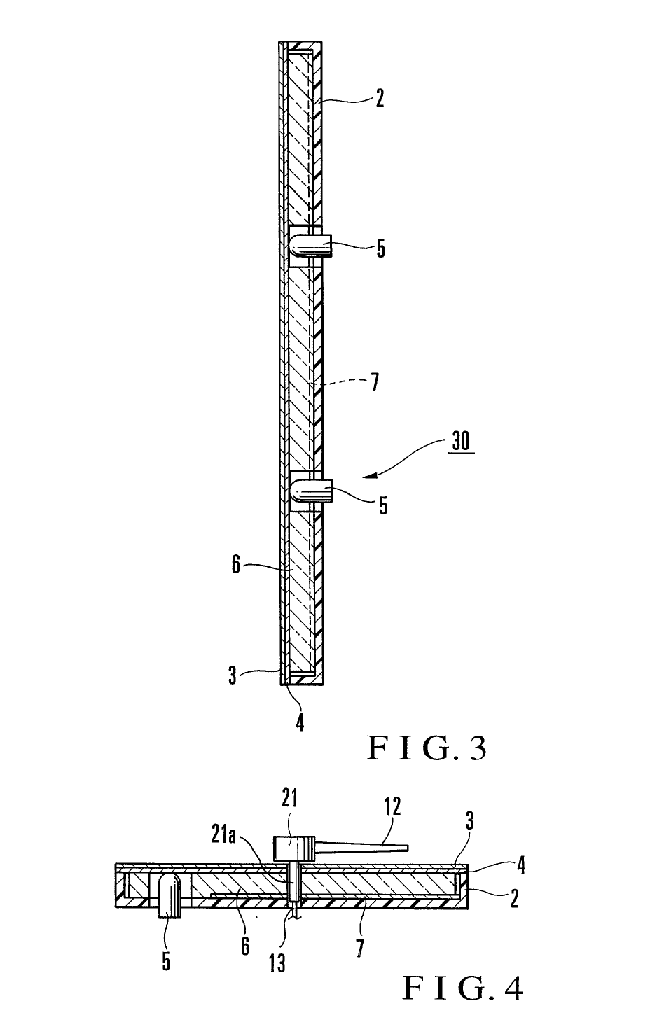

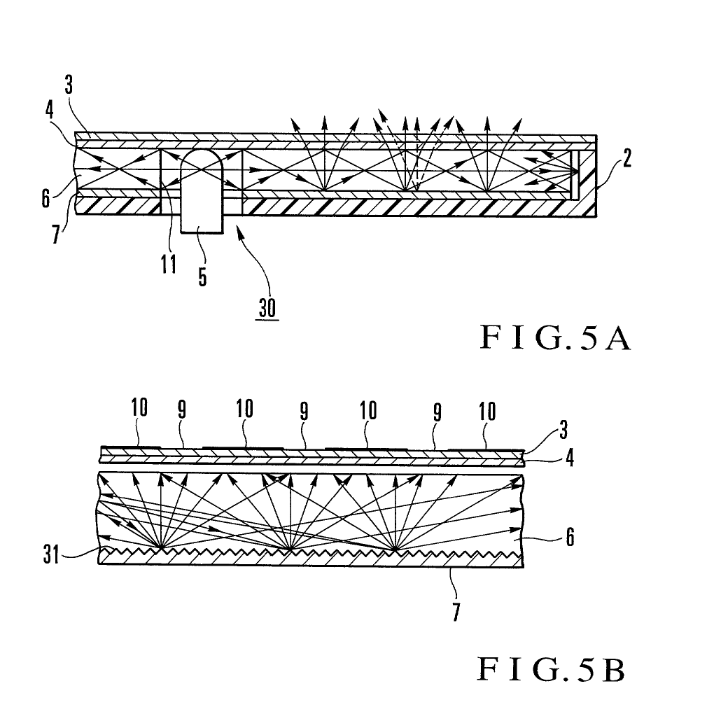

FIG. 1 shows the main part of an automobile analog display indicator as an application of a surface emission light source device according to an embodiment of the present invention, FIG. 2 shows a light guide plate, FIGS. 3 and 4 show this indicator, FIG. 5A shows the main part of this indicator, and FIG. 5B shows the main part of the light guide plate. In FIGS. 1 to 5B, constituent members and the like identical to those shown in the prior arts are denoted by the same reference numerals.

Referring to FIGS. 1 to 5B, in this embodiment, a surface emission light source device 30 is formed of two incandescent lamps (light sources) 5 as the light source, a light guide plate 6 for diffusing and reflecting light from the light bulbs 5 and guiding it to the front surface of a dial 3, and a reflecting plate 7 formed on the lower surface of the light guide plate 6. The surface emission light source device 30 illuminates the entire surface of the dial 3 from the lower surface with substantially uniform brightness.

In the dial 3, the entire front surface of a crystal-clear transparent material such as a polycarbonate resin is printed in white, and black printed portions (blanks of display portions) 10 are formed on portions other than display portions 9, e.g., numerals, characters, signs, and figures. The light bulbs 5 are arranged behind the dial 3. Light from the light bulbs 5 is guided to the front surface of the light guide plate 6 and diffused by a light-diffusing plate 4, thereby illuminating (by transmission) the display portions 9.

The light guide plate 6 is made of a transparent synthetic resin, e.g., an acrylic or polycarbonate resin, having good light transmission characteristics, and is formed with light source holes 11 into which the light bulbs 5 are to be inserted, and holes 14 through which cylindrical portions 21a of indicator caps 21 extend. When an acrylic resin is employed, its light refractive index n is 1.4779. The cylindrical portions 21a of the indicator caps 21 are coupled to shafts 13 of cross coils (not shown) that drive the analog display indicator.

Light emitted by the light bulbs 5 to come incident on the light guide plate 6 is multiple-reflected by the upper and lower surfaces of the light guide plate 6 and emerges to the front surface. The reflecting plate 7 is used to diffuse and reflect light emitted by the light bulbs 5 and propagating through the light guide plate 6, and to cause it to emerge from the front surface of the light guide plate 6. More specifically, the reflecting plate 7 diffuses and reflects light leaking to the lower surface of the light guide plate 6 and causes it to come incident on the light guide plate 6 again, so that light is utilized effectively. For this purpose, the surface of the reflecting plate 7 which is to be bonded with the light guide plate 6 forms an irregular (diffusion) reflection surface 31 made of fine, irregular corrugations.

The light guide plate 6 and reflecting plate 7 are integrally formed by insert or outsert molding so as not to form an air layer between them. In molding, the reflecting plate 7 is placed in the mold, as will be described later, and a molten resin for forming a light guide plate is filled in the mold, thereby molding the light guide plate 6 integrally with the reflecting plate 7. Even if the corrugations of the irregular-reflection surface 31 have the shape of an overhang, i.e., the shape in which a projection hangs into a recess to make the opening of the recess to be narrower than the deep side of the recess, the resin will not flow into the overhang to flatly bury the corrugations of the overhang, and the lower surface of the light guide plate 6 and the irregular-reflection surface 31 of the reflecting plate 7 can be completely brought into tight contact with each other.

When integrally molding the light guide plate 6 and reflecting plate 7, for example, the reflecting plate 7 is not arranged to cover the entire lower surface of the light guide plate 6, but is excluded from a portion near the light source where the amount of light is large, a portion where the amount of light reflected by the side surface of the light guide plate 6 is large, or a portion on the dial 3 where the display portions 9 (characters, numerals, signs, figures, and the like) are not formed, as indicated by hatched portions in FIG. 1. This reduces the amount of expensive reflecting material to be used. Since the reflecting plate 7 is arranged at only a necessary portion, light from the light bulbs 5 can be utilized effectively.

The reflecting plate 7 is formed by applying a light-diffusing agent, formed by dispersing fine light-diffusing particles in a binder resin, to the surface of a light-diffusing film base and solidifying the light-diffusing agent. As the material of the light-diffusing film, polyethylene terephthalate, an acrylic resin, or polycarbonate can be used. As the material of the binder resin, for example, an acrylic resin, a polyester-based resin, or an epoxy-based resin is used. As the fine light-diffusing particles, for example, fine particles of inorganic beads (e.g., glass beads), an inorganic filler (e.g., calcium carbonate), or organic beads (e.g., polyethylene particles or acrylic particles) can be used singularly, or a mixture obtained by mixing two or more members selected from this group can be used.

As the reflecting plate 7 having such fine light-diffusing particles, for example, Super Reflector No. 4596 available from Sumitomo 3M K.K. is known (this will be described later).

Alternatively, the reflecting plate 7 can be formed of a thermoplastic polyester foam (for example, see PCT Laid-Open WO97/01117). According to a method of manufacturing a reflecting plate disclosed in International Patent Publication WO97/01117, a roll is formed by rolling a thermoplastic polyester sheet and a separator stacked on the sheet. As the separator, an unwoven resin fabric or a metal net, through which an inert gas and organic solvent can pass freely, is suitable.

This roll is impregnated with an organic solvent such as benzene to set the degree of crystallization of the thermoplastic polyester sheet to 30% or more.

The roll impregnated with the organic solvent is put in a high-pressure vessel, is pressurized, and is held in an inert gas atmosphere to make the thermoplastic polyester sheet contain an inert gas such as helium, nitrogen or the like that serves as a foaming agent.

Subsequently, the roll is removed from the high-pressure vessel. While removing the separator, only the thermoplastic polyester sheet containing the inert gas is heated to foam it. A reflecting plate having irregular corrugations on its surface is obtained.

As a reflecting plate made of such a foam, for example, reflection film Ref-White RW188 available from K.K. Kimoto and an ultrafine foamed reflecting plate (MCPET) available from Furukawa Electric Co., Ltd. are known (this will be described later).

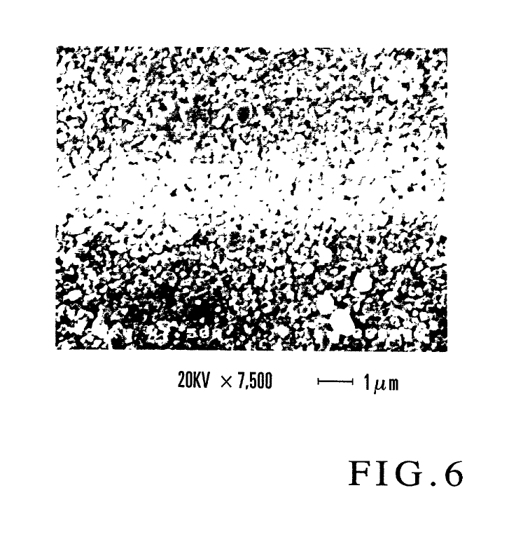

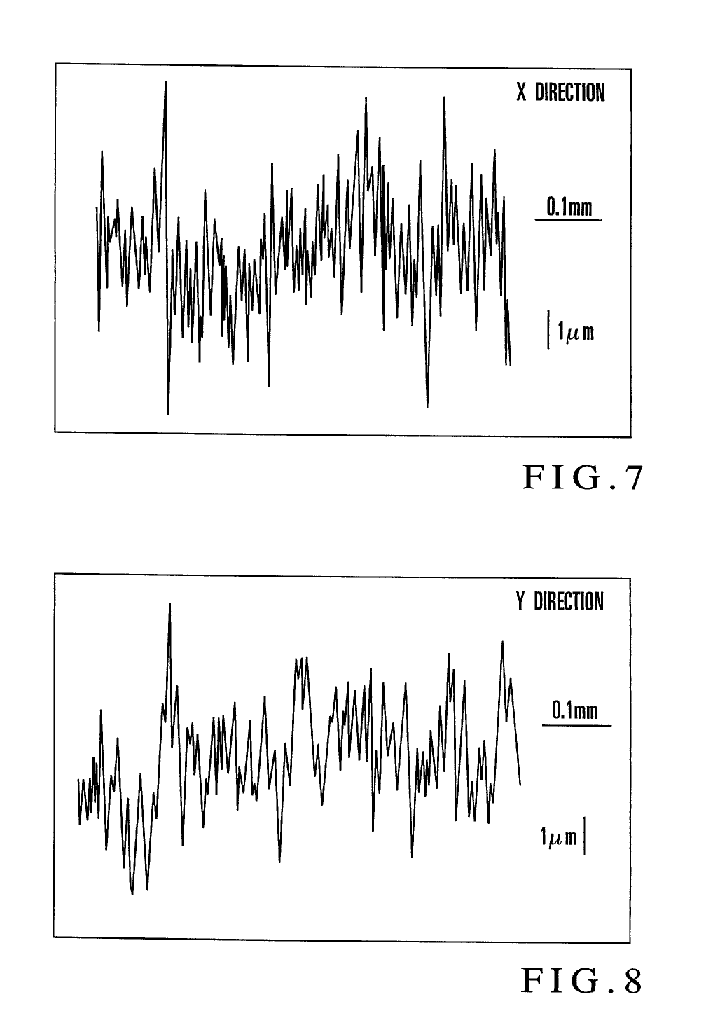

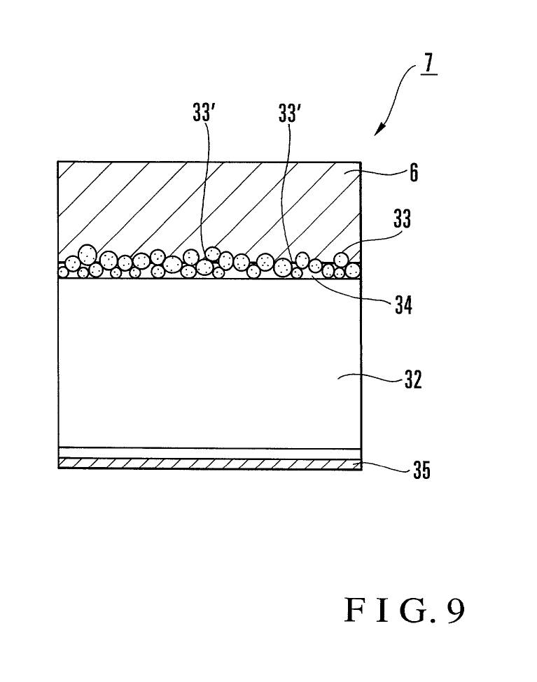

FIG. 6 shows a microscopic photograph of the surface of Super Reflector No. 4596 available from Sumitomo 3M K.K., FIG. 7 shows a graph obtained by measuring the X-direction surface roughness of this reflector, FIG. 8 shows a graph obtained by measuring the Y-direction (a direction perpendicular to the X direction) surface roughness of this reflector, and FIG. 9 shows the sectional image of this reflector after molding a light guide plate. Referring to FIG. 9, reference numeral 32 denotes a light-diffusing film as the base material of the reflecting plate 7; 33, fine light-diffusing particles (corrugations); and 34, a binder resin. The binder resin 34 forms a light-diffusing agent together with the fine light-diffusing particles 33. Reference numeral 35 denotes a white ink. When the irregular-reflection surface is formed by applying the light-diffusing agent to the surface of the light-diffusing film 32, of the fine light-diffusing particles 33 partly exposed to the surface of the binder resin 34, those projecting from the surface of the binder resin 34 have projecting portions that form projections, and a gap between the adjacent fine particles 33 form a recess. If the maximum-width portion of a fine particle 33 projects from the binder resin 34, this maximum-width portion covers the opening of the recess formed between the adjacent fine particles, thus forming a so-called overhang 33′ (FIG. 9).

Referring to FIG. 6, the size of the fine light-diffusing particles 33 was 0.1 μm to 2 μm. Referring to FIGS. 7 and 8, the X-direction maximum and minimum heights and Y-direction maximum and minimum heights of the surface roughness complying with the JIS B0601 were 1 μm, 0.01 μm, 0.8 μm, and 0.013 μm, respectively. The average X- and Y-direction peak-to-peak distances were 8.8 μm and 10.5 μm, respectively.

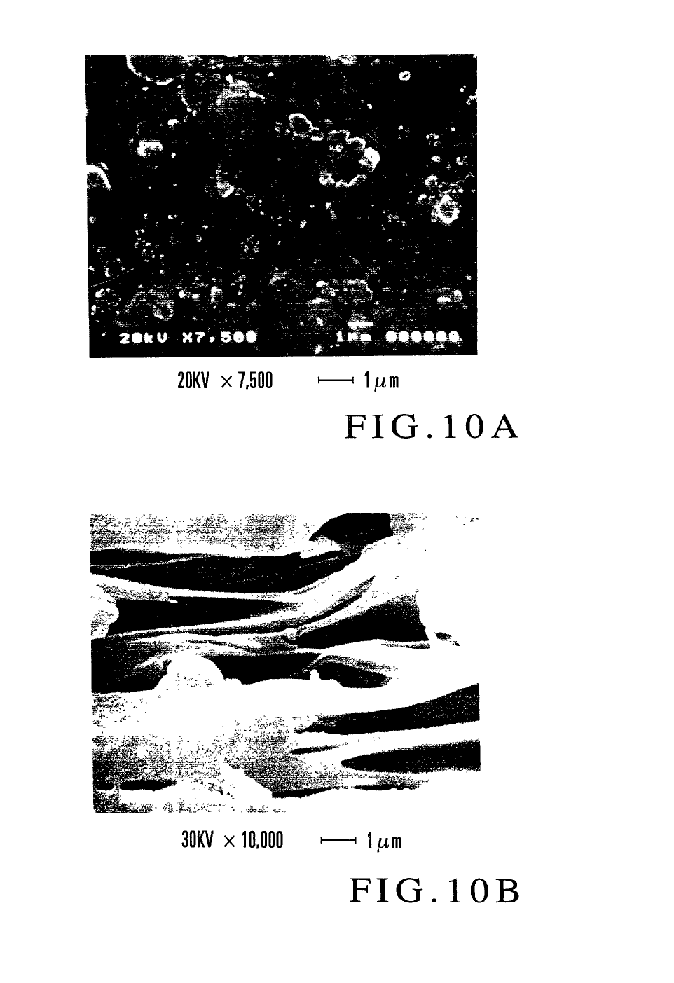

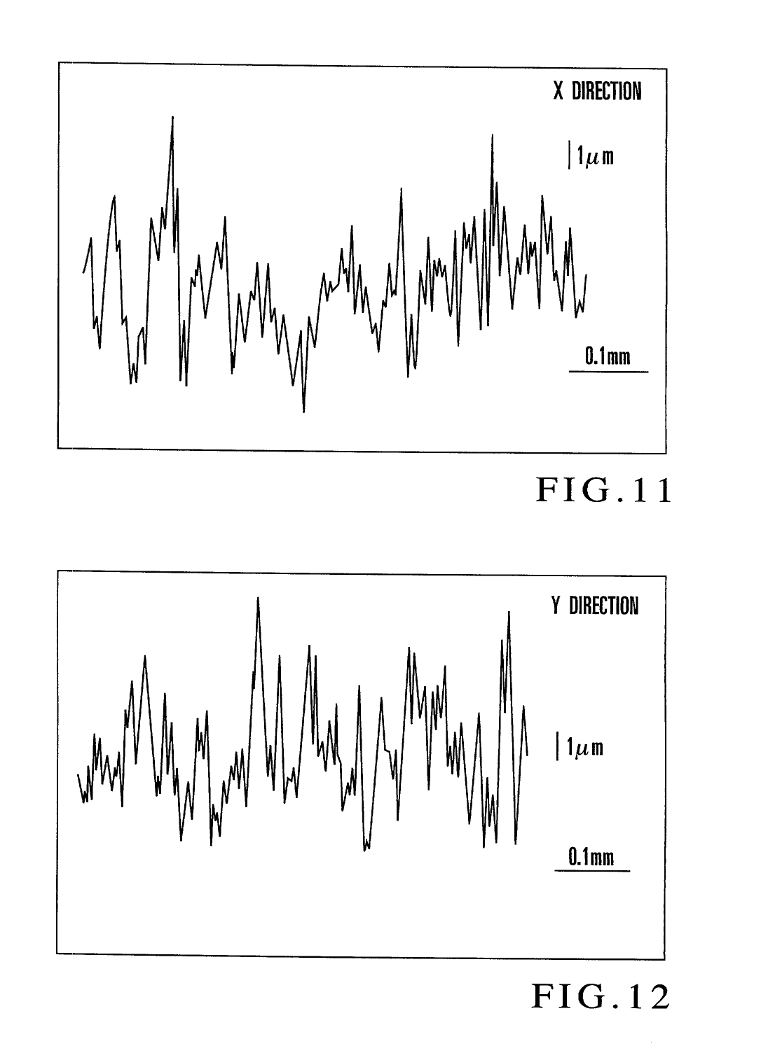

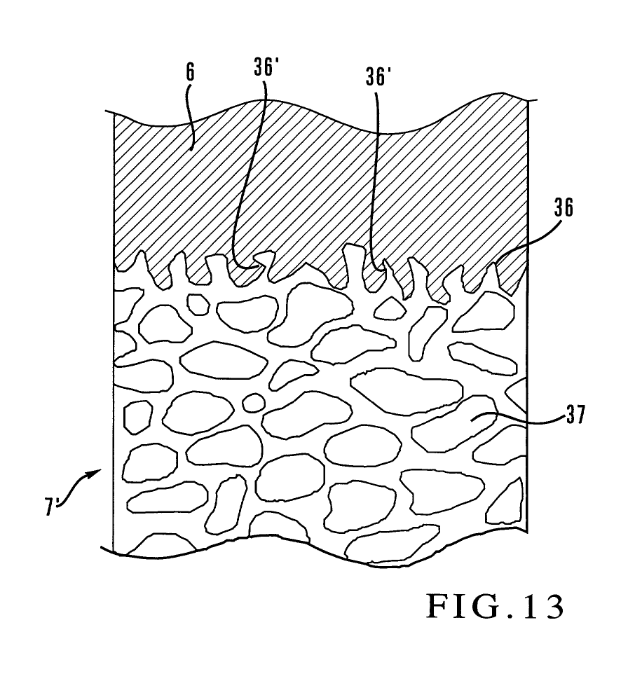

FIG. 10A shows a microscopic photograph of the surface of Reflection Film Ref-White RW188 available from K.K. Kimoto, FIG. 10B shows a sectional photograph showing the foamed state of this film. FIG. 11 shows a graph obtained by measuring the X-direction surface roughness of this film, FIG. 12 shows a graph obtained by measuring the Y-direction (a direction perpendicular to the X direction) surface roughness of this film, and FIG. 13 shows the sectional image of this film after molding a light guide plate. Referring to FIG. 13, a reflecting plate 7′ is formed of a polyester foam. Corrugations 36 are formed on the surface of the reflecting plate 7′ by foaming, and form an irregular-reflection surface. The corrugations 36 have irregular shapes, and some of their partial projections form overhangs 36′. Reference numeral 37 denotes a foamed portion.

Referring to FIGS. 11 and 12, the X-direction maximum and minimum heights and Y-direction maximum and minimum heights of the corrugations 36 according to the surface roughness complying with JIS B0601 were about 0.98 μm, 0.014 μm, 0.85 μm, and 0.01 μm, respectively. The average peak-to-peak distance was 10 μm (several μm to 10-odd μm). The size of the fine corrugation was about 0.1 to 3 μm from the two-dimensional photograph.

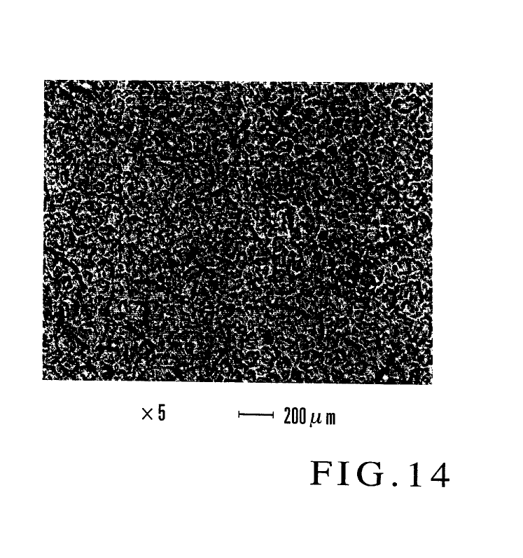

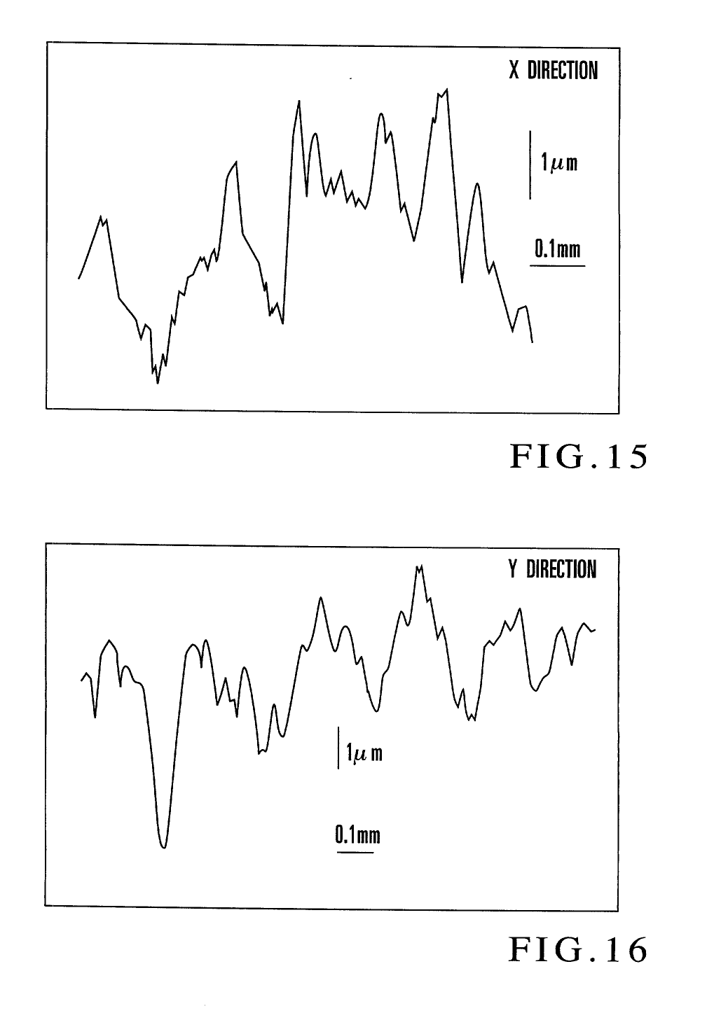

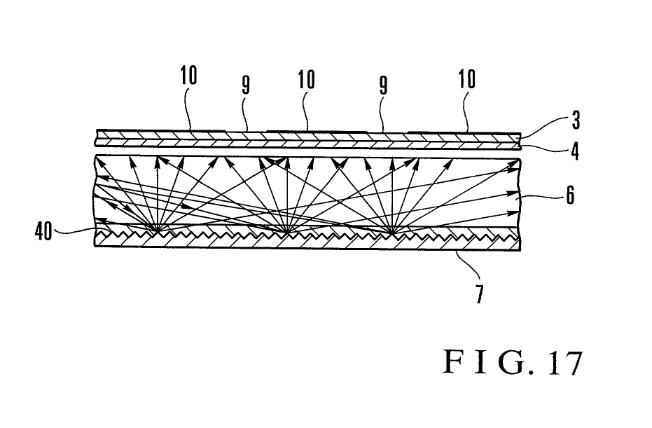

FIG. 14 shows the microscopic photograph of the surface of MCPET available from Furukawa Electric Co., Ltd. FIG. 15 shows the graph obtained by measuring the X-direction surface roughness of the MCPET, and FIG. 16 shows the graph obtained by measuring the Y-direction (perpendicular to the X direction) surface roughness of the MCPET. The size of the corrugation was 5 to 100 μm. The X-direction maximum and minimum heights and Y-direction maximum and minimum heights of the surface roughness complying with JIS B0601 were about 3.3 μm, 0.013 μm, 6 μm, and 0.01 μm, respectively. The average X- and Y-direction peak-to-peak distances were 21.5 μm and 40 μm, respectively.

As the reflecting plate, Super Reflector No. 4596, reflection film Ref-White RW188, and MCPET, respectively available from Sumitomo 3M K.K., K.K. Kimoto, and Furukawa Electric Co., Ltd. were used to measure the brightness. The brightness of each sample was higher than that of the conventional apparatus, and uniform illumination was achieved due to the following reason. Very fine, irregular corrugations are formed densely.

The depth (maximum height of surface roughness) of the corrugations 33 or 36 forming the irregular reflection surface 31 of the reflecting plate 7 or 7′ falls within the range of 1 μm (0.85 to 098 for Kimoto; 0.8 to 1 μm for Sumitomo 3M) to 6 μm (for Furukawa), and the reflecting plate should not have a smooth surface. The average size of the corrugation is about 10 μm for Kimoto and Sumitomo 3M and 40 μm (about 100 μm at maximum) for Furukawa. The surface has fine corrugations of 0.1 to 1 μm (for Sumitomo 3M) and 0.1 to 3 μm (for Kimoto).

The size of the corrugation preferably falls within the range of 0.1 to 100 μm. Within this range, light can be properly diffused and reflected. If the size is smaller than 0.1 μm or larger than 100 μm, it is found that the diffusion performance degrades. It is also found that better result can be obtained for smaller corrugations than larger corrugations.

The maximum height of the corrugations according to the surface roughness complying with JIS B0601 is about 0.8 to 6 μm. If the maximum height is smaller than 0.8 μm, the surface does not server as an irregular reflection surface. If the maximum height is Larger than 6 μm, light incoming to the recess is absorbed and an amount of light emerging from the recess :Ls undesirably reduced. Note that the height of the corrugation is determined by its size and increases with an increase in size of the corrugation. The maximum height for Super Refletor No. 4596 available from Sumitomo 3M K.K. and reflection film Ref-White RW188 available from K.K. Kimoto is about 0.8 μm, while the maximum height for MCPET available from Furukawa Electric Co., Ltd. is about 6 μm.

In the surface emission light source device having this structure, since the reflecting plate 7 is integrally formed with the light guide plate 6 by molding, no air layer is present between the plates 7 and 6, so that light propagating in the light guide plate 6 while being reflected can be directly guided to the reflecting plate 7. More specifically, if an air layer is present between the light guide plate 6 and reflecting plate 7, light having an angle equal to or larger than a critical angle is totally reflected by the boundary surface between the light guide plate 6 and the air layer. If no air layer is present between the light guide plate 6 and reflecting plate 7, this light is directly guided to the reflecting plate 7. The light is then diffused and reflected by the irregular-reflection surface 31, and transmitted through the light guide plate 6 and light-diffusing plate 4, to illuminate the display portions 9 of the dial 3.

Conventionally, of the light that is emitted by a light source and has come incident on the light guide plate, light that is reflected by the end face (side surface) of the light guide plate or the wall of the case disposed outside the light guide plate and repeats incidence on and reflection in the light guide plate is totally reflected by the boundary surface between the light guide plate and the air layer and disappears without being guided to the front surface of the dial. According to the present invention, however, the light can be effectively utilized in the absence of the air layer. Of light that has come incident on the light guide plate 6 from the light bulb 5, a light component reflected by the end face (side surface) of the light guide plate 6 or by the wall of a case 2 provided outside it to repeat incidence on and reflection in the light guide plate 6 is guided to the reflecting plate 7 during incidence and reflection, and is diffused and reflected by the irregular-reflection surface 31, so that it is transmitted through the light guide plate 6 and light-diffusing plate 4, to illuminate the display portions 9 of the dial 3. Therefore, the amount of light guided to the front surface of the dial 3 increases, and the entire dial 3 can be illuminated brightly with sufficiently uniform brightness.

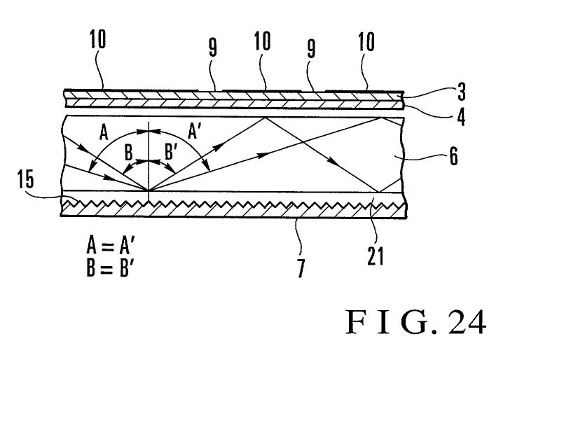

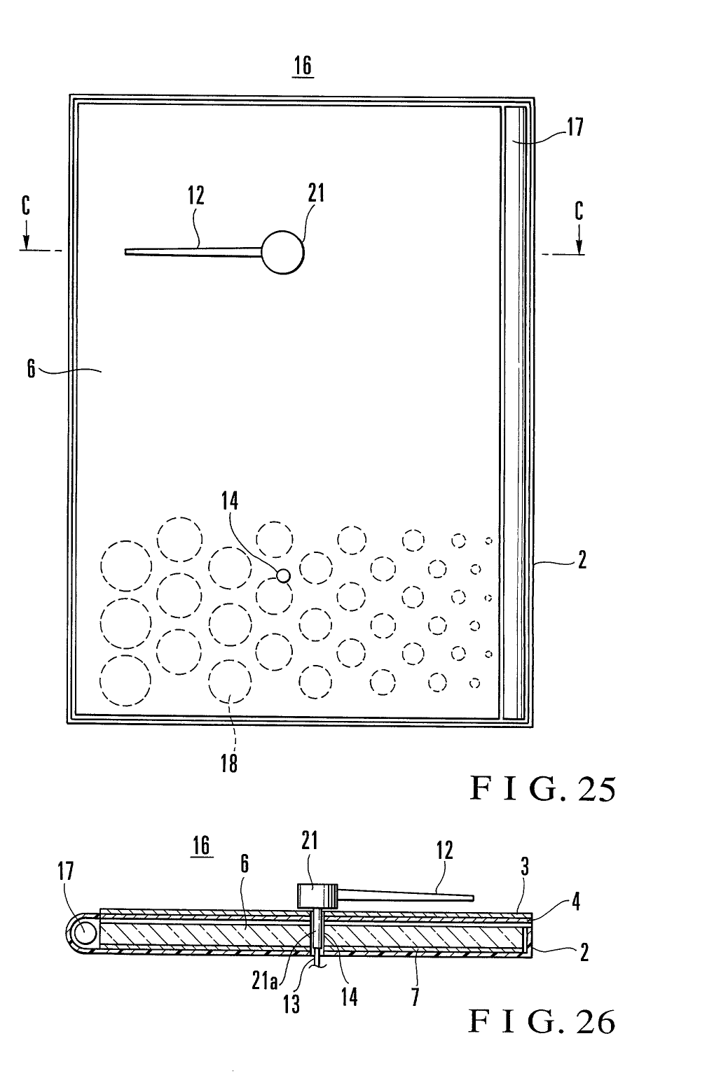

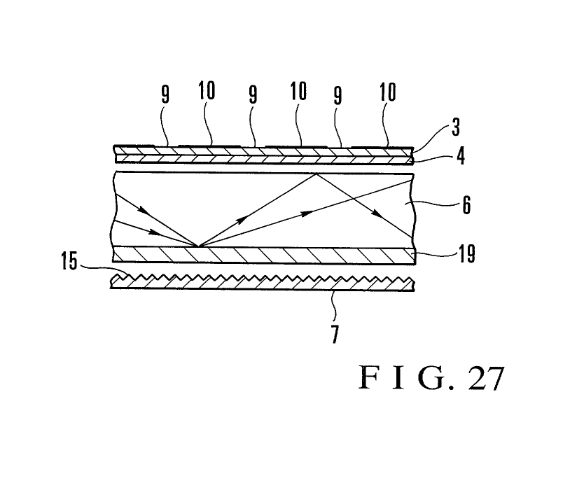

When the amount of light increases, the amount of light reaching the portions of shadows 22 shown in FIG. 24 also increases. This reduces a difference in brightness between portions where the shadows 22 are formed and portions where the shadows 22 are not formed, so that formation of the shadows 22 can be substantially prevented. More specifically, light propagating through the light guide plate 6 is shielded by the shafts 13 of the pointers 12 or the holes 14 through which the shafts 13 extend, and does not reach a side of the light guide plate 6 opposite to the light sources 5. Since this light propagates straight, not much light enters from the outside, and shadows are formed accordingly. When the light guide plate 6 and reflecting plate 7 are formed integrally, light propagating through the light guide plate 6 is irregularly reflected by the reflecting plate 7. Namely, the light is partly reflected at a critical angle (total reflection), is partly reflected toward the dial 3 to come incident on it, and is partly diffused and reflected in the light guide plate 6. Therefore, the amount of light reflected toward the dial 3 increases, and the reflected light also reaches the portions where the shadows are to be formed. As a result, the shadows become vague to a practically acceptable level, or formation of the shadows themselves can be prevented.

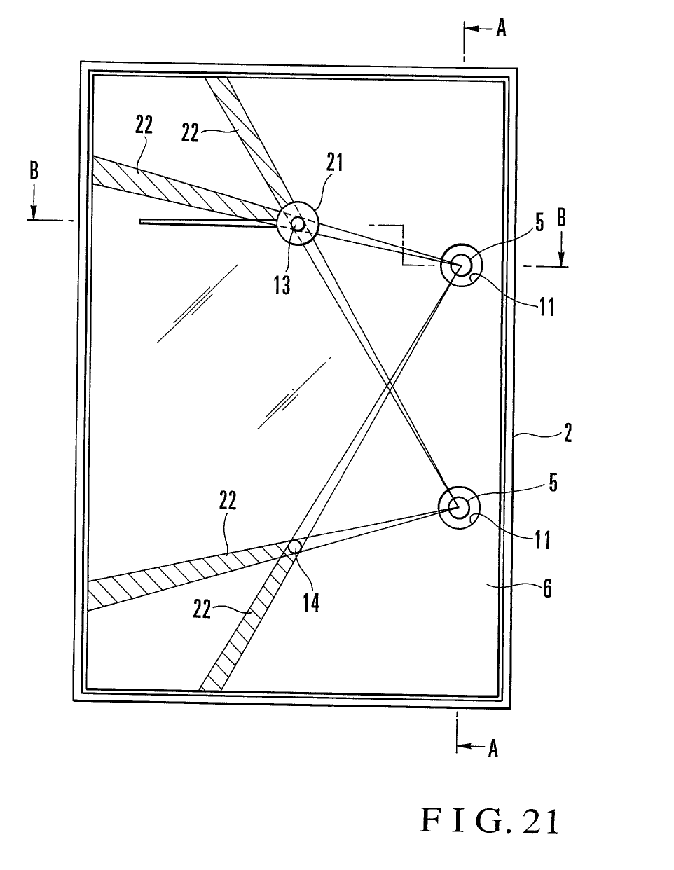

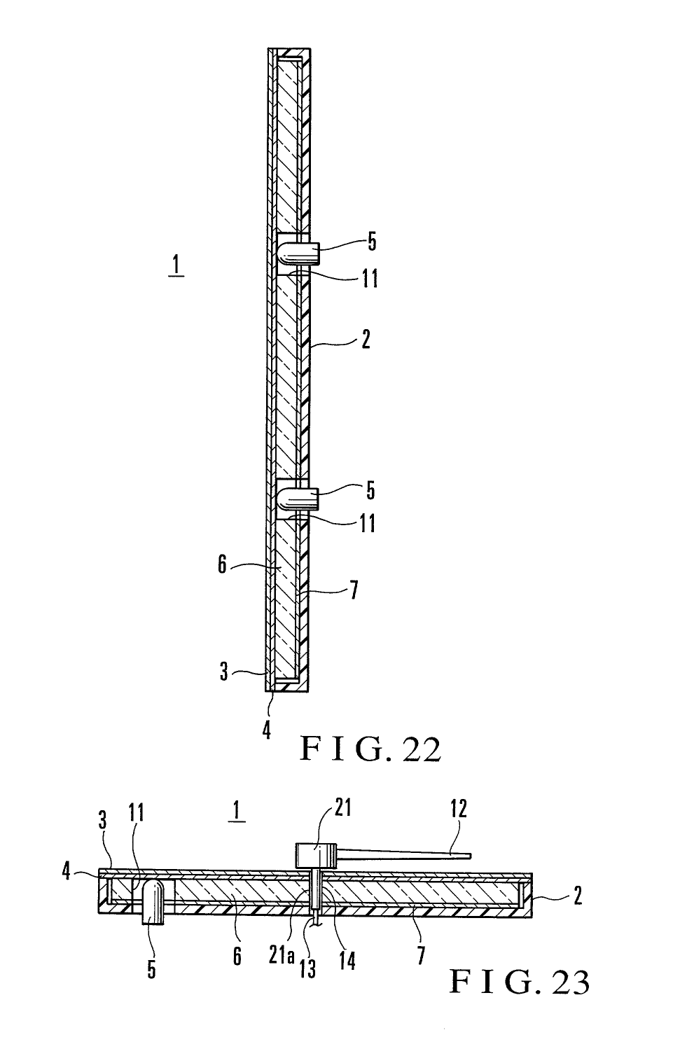

FIG. 21 shows the main part of another embodiment of the present invention.

In this embodiment, a reflecting plate 7 is bonded to the lower surface of a light guide plate 6 with a transparent cementing material (cementing solvent) 40 having a refractive index substantially equal to that of the light guide plate 6, so that no air layer is present between the light guide plate 6 and reflecting plate 7. As the cementing material 40, a pressure-sensitive adhesive, an adhesive, or the like is used. For example, highly transparent pressure-sensitive adhesive transfer tape #9483 available from Sumitomo 3M K.K., 1,2-dichloroethane(CH₂ClCH₂Cl), or the like is used.

To bond the light guide plate 6 and reflecting plate 7 to each other, the cementing material 40 may be applied to an irregular-reflection surface 31 of the reflecting plate 7 in advance, and the light guide plate 6 may be adhered to the irregular-reflection surface 31 through the cementing material 40. Alternatively, the cementing material 40 may be applied to or printed on the lower surface of the light guide plate 6 in advance, and the reflecting plate 7 may be adhered to this lower surface through the cementing material 40. In this case, the cementing material 40 need be applied to the entire bonding surface between the light guide plate 6 and reflecting plate 7. Even if an air spot is partially present on the bonding surface, as far as it does not noticeably change the luminance of a dial 3 as a whole, it poses no problem in actual use. When the cementing material 40 has a low bonding force or has substantially no bonding force, pins may be set upright from the light guide plate 6, and holes may be formed in the reflecting plate 7 at positions corresponding to the pins. Then, the reflecting plate 7 can be positioned, and can be fixed to the light guide plate 6 by caulking the pins. Alternatively, the reflecting plate 7 may be clamped under pressure between the light guide plate 6 and case Also in this structure, since no air layer is present between the light guide plate 6 and reflecting plate 7, the same effect as that obtained in the above embodiment can be obtained. More specifically, when the cementing material 40 is filled between the lower surface of the light guide plate 6 and the reflecting plate 7, light reflected in the light guide plate 6 is reflected by the boundary surface between the light guide plate 6 and cementing material 40. Since the refractive index of the cementing material 40 is substantially equal to that of the light guide plate 6, most light is incident on the reflecting plate 7 as compared to a case employing a combination of the light guide plate 6 and an air layer. The light is then diffused and reflected by the reflecting plate 7 and is transmitted through the cementing material 40 and light guide plate 6, so that it is guided to the front surface of the dial 3. Of light that has come incident on the light guide plate 6 from the light bulbs 5, a light component reflected by the end face (side surface) of the light guide plate 6 or by the wall of a case 2 provided outside it to repeat incidence and reflection in the light guide plate 6 is transmitted through the cementing material 40 and guided to the reflecting plate 7 during incidence and reflection, and is diffused and reflected by an irregular-reflection surface 31, so that it is transmitted through the cementing material 40, light guide plate 6, and light-diffusing plate 4, to illuminate display portions 9 of the dial 3. Therefore, in this case as well, the amount of light increases, the entire dial 3 can be illuminated brightly with sufficiently uniform brightness, and formation of shadows 22 can be prevented.

For example, if a cementing material 40 is to be printed in the form of dots only at portions corresponding to the display portions 9 indicated by hatched portions in FIG. 1, the dots may be formed densely (or by solid printing) only at the display portions 9 which should be illuminated brightly, thereby adjusting the unbalance of brightness and illuminating the desired part in a spot manner.

A method of manufacturing a light guide plate with a reflecting plate according to the present invention will be described.

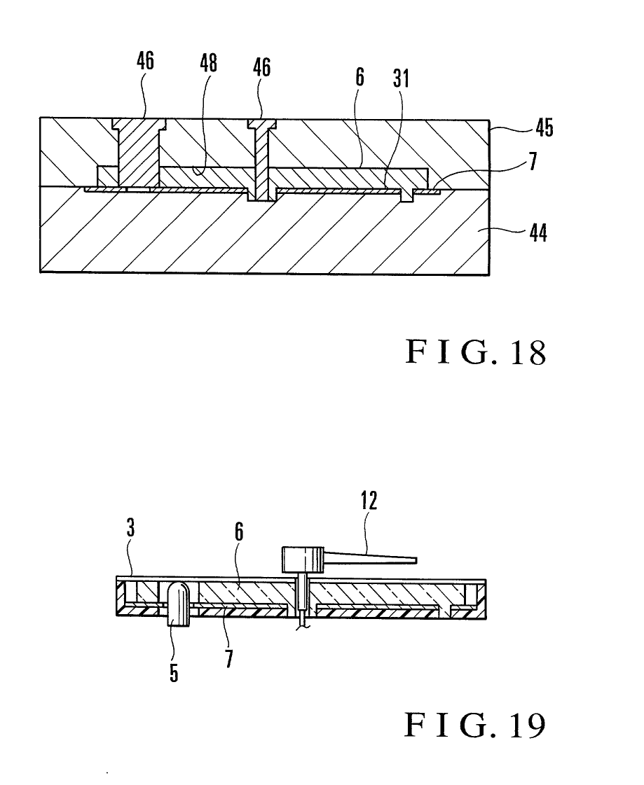

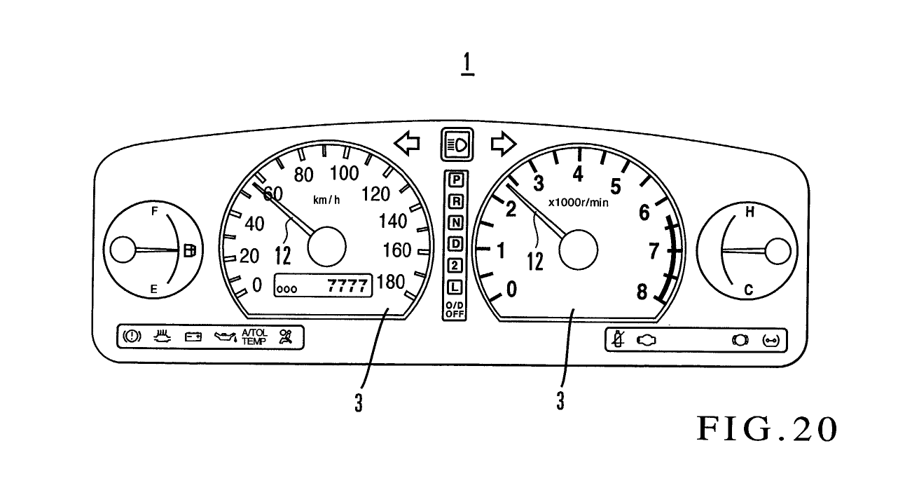

FIG. 18 shows a mold used when manufacturing a light guide plate by outsert molding, and FIG. 19 shows a surface emission light source device having a light guide plate formed by outsert molding.

Referring to FIG. 18, first, a reflecting plate 7 having an irregular-reflection surface 31 with a surface formed of irregular corrugations is formed. As such a reflecting plate 7, Super Reflector No. 4596 commercially available from Sumitomo 3M K.K. or Reflection Film Ref-White RW188 commercially available from K.K. Kimoto, both of which are described above, may be used.

The reflecting plate 7 is placed in a lower mold 44 such that its irregular-reflection surface faces up, and an upper mold 45 is positioned and fixed on the upper mold 45. Subsequently, a molten resin for forming a light guide plate is filled into a cavity 48 through an injection port (gate; not shown), to form a light guide plate 6 integrally with the irregular-reflection surface 31 of the reflecting plate 7. Reference numerals 46 denote pins for forming holes after molding.

When the light guide plate 6 is integrally molded with the reflecting plate 7 by outsert molding, even if the corrugations of the irregular-reflection surface 31 include those that form a so-called overhang, the molten resin enters the recesses well to reach their corners, so that the corrugations may not be buried flat.

In any of the embodiments described above, the present invention is applied to an automobile analog display indicator. However, the present invention is not limited to this, but can be used as a light source for various types of display indicators and display devices.

As has been described above, with the surface emission light source device according to the present invention, a light component emitted by the light source and coming incident on the light guide plate is guided to the reflecting plate. Also, conventionally, a light component, coming incident on the light guide plate and reflected by the end face (side surface) of the light guide plate or by the wall of a case provided outside it to repeat incidence and reflection in the light guide plate, is conventionally lost without being guided to the front surface of the dial. In the present invention, however, this light component is guided to the reflecting plate. These light components are diffused and reflected by the irregular-reflection surface of the reflecting plate, and are guided to the front surface of the dial. Therefore, the amount of light increases, and the dial can be illuminated bright. As a result, the number of point sources to be used can be reduced from three to two, and from two to one. Also, a light source having a smaller rated power can be used, which is advantageous in terms of cost, cooling, and the like.

Since the amount of light increases, formation of shadows can be substantially prevented. More specifically, light propagating through the light guide plate is shielded by the shafts of the pointers or the holes through which the shafts extend, and does not reach a side of the light guide plate opposite to the light source. Since this light propagates straight, not much light enters from the outside, and shadows are formed accordingly. When the light guide plate and reflecting plate are formed integrally, light propagating through the light guide plate is diffused and reflected by the irregular-reflection surface of the reflecting plate. Namely, the light is partly reflected at a critical angle (total reflection), is partly reflected toward the dial to come incident on it, and is partly diffused and reflected in the light guide plate. Therefore, the amount of light reflected toward the dial increases, and the reflected light also reaches the portions where the shadows are to be formed. As a result, formation of the shadows can be prevented.

When the amount of light increases, the shadows of the holes formed in the light guide plate to extend the pointers therethrough, and of the pointers can be made vague to a visually unnoticeable level. Hence, an inexpensive lamp can be used as the light source. Also, the surface of the dial corresponding to the reflecting plate can be entirely illuminated substantially uniform, except for a portion near the light source where direct incident light from the light source directly irradiates the dial. Therefore, dot printing aiming at balancing the brightness can be omitted, or even if it cannot be omitted, its specifications can be determined easily.

Furthermore, in the present invention, since the size of the corrugations of the irregular-reflection surface is 0.1 μm to 100 μm, light can be diffused and reflected well.

What is claimed is:

1. A surface emission light source device comprising a light source, a light guide plate for guiding light from said light source and causing the light to emerge from a front surface thereof, and a reflecting plate, having an irregular-reflection surface formed of irregular corrugations and disposed on a lower surface of said light guide plate, to diffuse and reflect the light guided through said light guide plate with said irregular-reflection surface and to cause the diffused/reflected light to emerge from said front surface of said light guide plate,
wherein said light guide plate and said reflecting plate are integrally formed by molding, to bond said irregular-reflection surface to said lower surface of said light guide.

2. A surface emission light source device comprising a light source, a light guide plate for guiding light from said light source and causing the light to emerge from a front surface thereof, and a reflecting plate, having an irregular-reflection surface formed of irregular corrugations and disposed on a lower surface of said light guide plate, to diffuse and reflect the light guided through said light guide plate with said irregular-reflection surface and to cause the diffused/reflected light to emerge from said front surface of said light guide plate,
wherein said reflecting plate is bonded to said lower surface of said light guide plate through a cementing material having a refractive index substantially equal to that of said light guide plate, thereby bonding said irregular-reflection surface to said lower surface of said light guide plate.

3. A device according to claim 1, wherein said corrugations of said irregular-reflection surface have a size of 0.1 μm to 100 μm.

4. A device according to claim 2, wherein said corrugations of said irregular-reflection surface have a size of 0.1 μm to 100 μm.

5. A method of manufacturing a light guide plate with a reflecting plate, comprising the steps of:
placing a reflecting plate having an irregular-reflection surface with a surface formed of irregular corrugations in a mold; and
injecting a light guide plate-forming molten resin in said mold, thereby integrally forming a light guide plate on said irregular-reflection surface of said reflecting plate.

6. A method of manufacturing a light guide plate with a reflecting plate, comprising the steps of applying a cementing material to an irregular-reflection surface of a reflecting plate or a lower surface of a light guide plate, said irregular-reflection surface having a surface formed of irregular corrugations, and said cementing material having a refractive index substantially equal to that of said light guide plate, and bonding said reflecting plate to said light guide plate.
